(19) United States
(12) Patent Application Publication
(10) Pub. No.: US 2014/0310096 A1
(43) Pub. Date: Oct. 16, 2014

(54) Global Commerce Synergy

(71) Applicant: Anuthep Benja-Athon, New York, NY (US)

(72) Inventor: Anuthep Benja-Athon, New York, NY (US)

(21) Appl. No.: 13/864,195

(22) Filed: Apr. 16, 2013

(51) Int. Cl. G06Q 30/02

(52) U.S. Cl. CPC G06Q 30/0251; G06Q 30/0201
USPC 705/14.49

(57) ABSTRACT

A system and method for advising and guiding global businesses, companies and corporations, consumers and buyers how to offer, examine, sell and buy goods and services through networks based on networked devices disseminating and sharing experiences, knowledge and data on online offerings, examinations, sold and bought goods and services represented by a plurality of adaptable series of complementary interactive pictures and associated information associating and endowed with a plurality of adaptable themes and trends and compositions of suggestions and recommendations on the offerings, examinations, buys and sells of goods and services in the viewing screens in and among specific and network-selected devices.

This is a continuation-in-part of application of Ser. No. 13/678,096 filed on Nov. 15, 2012 entitled the global super store.

### FIELD OF THE INVENTION

A system and method for sharing and disseminating experiences and knowledge on offerings, examinations, buys and sells of goods, commodities and services by and among businesses, companies and corporations and consumers and buyers through networks.

### BACKGROUND OF THE INVENTION

Despite technological advances, there exists no brick-and-motar and digital platforms for supporting domestic and global commerce, trades and businesses of goods, commodities and services among millions of enterprises, companies and corporations and billions of people. Consequently, millions of random, obscure and oblivious offerings, buys and sells of goods, commodities and services by and among disconnected local and international businesses, companies and corporations and consumers and buyers every day were heretofore based on the archaic system of random, unintelligent, expensive and, therefore, ineffective commerce, trades and businesses attributing to high costs, wastes and losses for humanity.

The present invention provided a system and method for advising and guiding businesses, companies and corporations and people how to offer, examine, buy and sell goods, commodities and services in the global commerce synergy through networks of relevant, specific and network-selected fix and mobile communication devices networked to servers so that specific advises and guidances are presented to relevant, specific and network-selected devices.

### SUMMARY OF THE INVENTION

Domestic and global commerce, trades and businesses heretofore are based on an archaic system of random, unintelligent, expensive and, therefore, ineffective communications by and among sellers, buyers and consumers attributing to high costs and wastes inflicted upon the above.

The present invention provides the global business-business-people commerce synergy by providing a system and method for advising and guiding global businesses, companies and corporations, consumers and buyers how to offer, examine, buy and sell goods, commodities and services through networks. The system is based on networked devices disseminating, streaming and pushing and sharing experiences, knowledge and data on goods, commodities and services offered, examined, sold and bought online by and among businesses, companies and corporations, consumers and buyers represented by a plurality of adaptable series of complementary interactive pictures and associated information associating and endowed with a plurality of adaptable themes and trends and compositions of suggestions and recommendations on the offerings, examinations, buying and selling of goods, commodities and services in the viewing touchscreens and opening screens in and among specific and network-selected devices.

### DESCRIPTION OF THE PREFERRED EMBODIMENTS

The present invention provided a system and method for advising and guiding businesses, companies and corporations and people how to offer, examine, buy and sell goods, commodities and services based on said system and method sharing and disseminating including streaming, pushing and pulling of information on and related to experiences, knowledge and data on offerings, examinations, buys and sells of goods, commodities and services associating with information on a plurality of adaptable themes and trends and compositions of suggestions and recommendations of goods, commodities and services offered, examined, sold and bought online by and among businesses, companies, corporations and people through said networks. Said information on a plurality of adaptable themes and trends and compositions associating with and endowed and inherent in a plurality of adaptable series of complementary interactive images and pictures and associated information in said viewing screens of and among networked devices. Each of said mobile interactive images in the viewing screens are linked to associating interactive information on said goods, commodities and services and related businesses, companies, corporations and consumers and buyers in Web pages in said viewing screens.

The present invention provided said networks comprising said servers including cloud and virtual servers comprising commercially available storage memories comprising said commercially available and open-source SQL and NoSQL databases and the likes—which are commercially available or are open sources—comprising data generated in, by, disseminated and shared in and among said networked servers and devices. Said devices comprising desktops, computer tablets, mobile communication devices including smartphones, satellites and teleconferencing platforms. Said networked servers and devices comprising processor units coupled to innovative computer programs and software comprising computer codes and instructions for instructing and specifying said processor units in said networked servers and devices and said servers and devices. Said servers and devices further have networking capabilities and technologies for streaming, pushing, pulling and sharing said plurality of adaptable series of images and associated information to, from and among said devices and servers in said networks. Said networking capabilities and technologies for streaming, pushing, pulling and sharing are commonly and commercially available from many American and European technology companies and corporations.

Said devices comprise viewing screens comprising touchscreens or touch-sensitive screens and opening screens. An opening screen of a device is the first screen when said device is turned on by the user or booted from off or hibernation of the device.

Said databases comprising relations of said images and associated information from which relevant relations are expressed as a plurality of adaptable series or sequences of complementary interactive images and pictures and associated information associating and endowed with a plurality of adaptable themes and trends and compositions of suggestions and recommendations on the offerings, examinations, sells and purchases of said goods, commodities and services in the viewing screens of relevant, specific and network-selected devices. Said goods, commodities and services henceforth goods and services comprise, but not limited to, consumer staples, consumer discretionaries, foods, fuels, commodities, products, machineries, financials, commercial and residential housings, services and transportation, etc. offered, examined, sold and bought by and among businesses, companies, corporations and people through networks from data on submitted images and associated information in said databases based on algorithms for instructing processor units of said servers how to generate, compose, change, adapt and update said plurality of adaptable series of images and associated information associating and endowed with said adaptable themes and trends and compositions.

Said databases further comprise demographics and business profile and information of said businesses, companies, corporations and demographics of consumers and buyers of said goods and services such as, but not limited to, industries and services, socioeconomic information including annual wages and income brackets, genders, ages, ethnicity, features, preferences, life styles, health and healthcare information, diets, nutrition, medications, religions, believes, avocations, hobbies, interests, addresses and locations of homes, residences and places of living and works, telephone and smartphone numbers including country codes and area codes, etc.

Further to supra, said databases comprising relations of said images and associated information associating and endowed with said themes and trends and compositions of suggestions and recommendations being expressed in said viewing screens comprise data on the numbers, sequences, frequencies, repetitions and recurrences referencing to time and spatial locations of touched or clicked images and associated or without information submitted touched or clicked images with associating information or without information, durations between each touched or clicked image and associated information and the next touched or clicked image and associated information, sharing and insertions of said touched or clicked images and associated information in and among networked devices, identities of said devices and demographics of users of said devices, said themes and trends and compositions of sequences of touched or clicked images and associated information in an adaptable series of interactive images and associated information in a touchscreen or an opening screen, said data are processed by said processor units and stored in said databases.

Said databases are generated and compiled by said innovative computer programs and software and commercial data analytics and statistics analyses to enable said processor units to analyze and process submitted images and information with said data and compilations in said databases to generate and compose or change, adapt and update said plurality of adaptable series associating and endowed with said plurality of adaptable themes and trends and compositions of suggestions and recommendations in said viewing screens of and among relevant, specific and network-selected devices based on said submitted images and information and compiled data on said goods and services offered, examined, sold and bought generated and submitted by and among said networked devices for generating and submitting images and information to said servers.

One of the preferred embodiments of the present invention applying said databases comprising relations of said images and associated information associating and endowed with said adaptable themes and trends and compositions of suggestions and recommendations being expressed in said viewing screens comprise data on the numbers, sequences, frequencies, repetitions and recurrences referencing to time and spatial locations of touched or clicked images and associated or without information submitted touched or clicked images with associating information or without information, durations between each touched or clicked image and associated information and the next touched or clicked image and associated information, sharing and insertions of said touched or clicked images and associated information in and among networked devices, identities of said devices and demographics of users of said devices, said compositions of sequences of touched or clicked images and associated information in an adaptable series of interactive images and associated information in a touchscreen or an opening screen, said data are processed by said processor units and stored in said databases.

Yet another preferred embodiment of the present invention applying said databases comprising relations of said images and associated information associating and endowed with said themes and trends and compositions of suggestions and recommendations being expressed in said viewing screens comprise data on the numbers, sequences, frequencies, repetitions and recurrences referencing to time and spatial locations of touched or clicked images and associated or without information submitted touched or clicked images with associating information or without information, durations between each touched or clicked image and associated information and the next touched or clicked image and associated information, sharing and insertions of said touched or clicked images and associated information in and among networked devices, identities of said devices and demographics of businesses, companies and corporations and people using and associated with said devices henceforth users, said compositions of sequences of touched or clicked images and associated information in a plurality of adaptable series of interactive images and associated information in a touchscreen or an opening screen, said data are processed by said processor units and stored in said databases.

The present invention provided said innovative computer programs and software for instructing said processor units of said servers how to compose a plurality of series of complementary images and associated information associating and endowed with adaptable themes and trends and compositions of suggestions and recommendations of goods and services offered, examined, sold and bought by and among businesses, companies, corporations and people through networks from data on submitted images and associated information in said databases based on algorithms for instructing processor units of said servers how to generate, compose, change, adapt and update said plurality of adaptable series of images and associated information associating and endowed with said adaptable compositions. Said servers disseminate, stream and push said plurality of series of complementary images and associated information associating and endowed with adaptable compositions of themes, trends, suggestions and recommendations to said viewing screens including opening screens of specific and network-selected devices. One of the preferred embodiments of the present invention, said servers disseminate, stream and push said plurality of series of complementary images and associated information associating and endowed with adaptable themes and trends and compositions of suggestions and recommendations to said viewing screens including opening screens of specific and network-selected devices consequent to images and associated information being selected and submitted by networked devices to said servers wherein said processor units processed said submissions with said databases to generate and compose said plurality of series of complementary images and associated information associating and endowed with adaptable themes and trends and compositions of suggestions and recommendations.

Said innovative computer programs and software have algorithms for instructing said processor units of said servers how to:

i. compose said plurality of adaptable series associating and endowed with specific themes and trends and compositions of suggestions and recommendations in said viewing screens of and among specific and network-selected devices whenever said devices submitted images and associated information to said servers;
ii. generate and compose or change, adapt and update said plurality of said adaptable series of images and associated information associating and endowed with said plurality of adaptable themes and trends and compositions of suggestions and recommendations in said viewing screens of and among specific and network-selected devices based on submitted images and information relating to said databases in said storage memories, said adaptable series and associating adaptable themes and trends and compositions of suggestions and recommendations are relevant to specific and network-selected devices;
iii. compose impressive, memorable and noteworthy themes and trends and compositions of suggestions and recommendations associating with and inherent to said adaptable series of images and associated information;
iv. compose impressive, memorable and noteworthy themes and trends and compositions of suggestions and recommendations associating with and inherent to said adaptable series of images and associated information.

Said algorithms are generated and programmed into said processor units for instructing said processor units how to process submitted images and information with said databases to generate and compose and change, adapt and update said plurality of adaptable series of images and associated information associating and endowed with a plurality of themes and trends and compositions of suggestions and recommendations of goods and services offered, examined, sold and bought by and among businesses, companies, corporations and people based on data on submitted images and information relating to said databases whenever images and information are selected and submitted by said devices to said servers through networks, said plurality of said adaptable series of images and associated information are relevant to specific and network-selected devices in said networks.

Said algorithms are generated and programmed into said processor units for instructing said processor units how to process submitted images and information relating to said databases to select images associating with information to be inserted into and to replace, reorder and adapt images and associated information in a plurality of adaptable series of complementary interactive images associating with information to change, adapt and update associating themes, trends, suggestions and recommendations associating with said series of complementary interactive images and associated information in said viewing screens of specific and network-selected devices, whenever said images and information are selected and submitted to said servers by said devices through networks.

Said innovative computer programs and software also provide said processor units with commercial data analytics and statistics analyses for enabling said processor units to analyze and process submitted images and information with said databases to generate and compose or change, adapt and update said plurality of adaptable series associating and endowed with said plurality of adaptable themes and trends and compositions of suggestions and recommendations in said viewing screens of and among relevant, specific and network-selected devices based on said submitted images and information and compiled data on said goods and services offered, examined, sold and bought generated and submitted by and among said networked devices for generating and submitting images and information to said servers.

The present invention provided said plurality of adaptable series of interactive images and associated information and associating plurality of adaptable themes and trends and compositions of suggestions and recommendations in and among said viewing screens are the outcomes of processor units processing images and associated information generated in and submitted by and among networked devices to said servers and of said servers disseminating said plurality of adaptable series associating and endowed with adaptable themes and trends and compositions of suggestions and recommendations to said viewing screens of and among specific and network-selected devices based on said algorithms and statistical analyses.

In one of the preferred embodiments of the present invention, said interactive images and information in networked devices instructing and specifying said processor units to generate and compose a plurality of series of complementary images and associated information and associated adaptable themes and trends and compositions of suggestions and recommendations and said processor units for instructing said servers to disseminate said plurality of series and associated information and associated adaptable themes and trends and compositions of suggestions and recommendations to said viewing screens of and among specific and processor units-selected devices through networks comprise interactive images and associated information in first networked devices wherein said images and associated information are related to a plurality of images and associated information in said databases and being displayed as a plurality of interactive images including said images and associated information in the viewing screens in and among specific and relevant networked second devices, said images and information in said first networked devices wherein said images and information for getting said a plurality of images and associated information associating with plurality of adaptable themes and trends and compositions of suggestions and recommendations to be displayed in said viewing screens of and among specific and processor units-selected devices including said first devices from said databases through networks.

In yet another preferred embodiment, said interactive images and information in networked devices for instructing said processor units of said servers to change, adapt, update and reorder images and information in adaptable series of complementary interactive images and associated information and associated adaptable themes and trends and compositions of suggestions and recommendations in said viewing screens of and among specific and network-selected devices comprise said interactive images and associated information in first networked devices wherein said images and associated information are related to a plurality of images and associated information in said databases and being displayed as a plurality of interactive images including said images and associated information in the viewing screens in and among specific and relevant networked second devices, said images and information in first networked devices wherein said images and information for updating, changing and adapting a plurality of adaptable series of interactive images and associated information and associated adaptable themes and trends and compositions of suggestions and recommendations in the viewing screens of specific and network-selected second devices through networks.

The present invention provides said plurality of adaptable series of interactive images and associated information comprise a plurality of different formats of slide-shows of complementary interactive images or pictures and a plurality of complementary interactive displayed icons and tiles comprising displayed series, sequences and orders for presenting relevant adaptable themes and trends and compositions of suggestions and recommendations in and among said viewing screens being seen by the eyes, impressed on and perceived by the brains of and among viewers of said viewing screens, each of said interactive images or pictures and icon is linked to associating information for achieving said and additional effects in the Web pages in said viewing screens in and among said networked devices through networks. Said formats of different types of slide-shows and different types of displayed icons and tiles are commercially used in viewing screens including opening screens of smartphones, computer tablets and desktops.

The present invention also includes a plurality of videos associating and endowed with adaptable themes and trends and compositions of suggestions and recommendations of goods and services offered, examined, sold and bought by and among businesses, companies, corporations and people through networks.

Said slide-shows and icons and tiles to complement said videos and vice versa in the viewing screens, in particular, said opening screens of said devices. Said servers can disseminate, stream and push said series and said themes and trends and compositions to specific and processor units-selected touchscreens, opening screens and Web pages of and among specific and processor units-selected devices wherein said series and themes and trends and compositions are rendered as plurality series or sequences of complementary interactive images and associated information associating and endowed with plurality of adaptable themes and trends and compositions of suggestions and recommendations.

In said preferred embodiments, the present invention provides said innovative computer programs and software coupled to servers processor units and said storage memories to process Big Data including structured and unstructured databases in said system storage or repository including cloud-based storage in said networks of servers and devices. Using enterprise search technology and web search technology for searching structured and unstructured data in said databases and data in the World Wide Web, and said data analytics and statistics analytics and commercial computer programs for enhancing said system to generate and compose series or sequences of images and information associating with impressive, memorable and noteworthy compositions of themes and trends and compositions of suggestions and recommendations to cause human memory to be imprinted with series, sequences, information, themes, trends and compositions like impriting songs, music and songs and musical and song lyrics, jingles, recitals, poems and common cultural, social, media and entertainment messages and imprints in the human mind. The significance and value of this preferred embodiments is to imprint the mind to retain and recall said plurality of advises, guidances, experiences and knowledge appeared in said viewing screens.

An example of said infinite series and sequences of complementary images and pictures and information associating and endowed with adaptable themes, trends and compositions in said slide-shows and a plurality of complementary interactive displayed icons and tiles and videos of complementary interactive images or pictures and associated information and associated adaptable themes and trends and compositions of suggestions and recommendations in and among said networked devices networked to said servers for streaming, pushing and sharing said slide-shows, icons and tiles and videos to said devices in said networks:

Through said networks, whenever images and/or information from said devices are submitted to cause said servers to generate, compose and disseminate including stream, push and share said slide-shows, icons and tiles and videos to and among specific and server-selected devices. For example, a plurality of series or sequences of complementary interactive images and pictures in said formats and means such as, but not limited to, images and pictures of land and sea transports, air-lines, hotels and accommodations, restaurants and diners, places of interest, etc. on and being provided by businesses, companies and corporations in various countries of originations and destinations of users of said devices in said global business-business-people commerce synergy. Said interactive images and pictures show relevant land and sea transports, air-lines, hotels and accommodations, restaurants and diners, places of interest, etc. for said vacation being provided by businesses, companies and corporations providing said goods and services in said originations and destinations. Said plurality of complementary interactive images and pictures are composed and ordered to produce associating themes and trends and compositions of suggestions and recommendations for the offerings, examinations, sells and purchases of said goods and services based on said data on the numbers, sequences, frequencies, repetitions and recurrences referencing to time and spatial locations of touched or clicked images and associated or without information submitted touched or clicked images with associating information or without information, durations between each touched or clicked image and associated information and the next touched or clicked image and associated information, sharing and insertions of said touched or clicked images and associated information in and among networked devices, identities of said devices and demographics of users of said devices. Said plurality of themes and trends and compositions of suggestions and recommendations may be impressive, memorable and noteworthy for said users of said devices.

Further to supra, interactive images of, say, an image or picture of an air-line and/or a hotel, etc. and/or associated information in said touchscreens and opening screens of said devices can be touched and selected individually or in series and submitted to said servers. Said selection(s) is/are submitted to said servers wherein said submission(s) instructing said processor units to generate and compose a plurality of series of complementary images and associated information and associated adaptable themes and trends and compositions of suggestions and recommendations based on said databases comprising said data and Big Data and algorithms; said processor units instruct said servers to disseminate, stream and push yet other sets of compositions series of images and pictures and/or videos and associated information and associated adaptable themes and trends and compositions of suggestions and recommendations to the viewing screens of and among specific and processor units-selected devices through networks.

Further to supra, interactive images of, say, an image or picture of an air-line and/or a hotel, etc. and/or associated information in said touchscreens and opening screens of said devices can be touched and selected individually or in series and submitted to said servers which are caused to select images and associated information to send to change, adapt, update and reorder images and information in said adaptable series of complementary interactive images and associated information and associated adaptable themes and trends and compositions of suggestions and recommendations in said viewing screens of and among specific and network-selected devices through networks. Said servers disseminate, stream and push said images and/or composed images, say, images or pictures of historical sites, hotels and accommodations, information routes, local cultures, foods and cuisines, etc. and associated information to be inserted to plurality of series of images and pictures and/or videos and associated information and associated adaptable themes and trends and compositions of suggestions and recommendations in the viewing screens of and among specific and processor units-selected devices through networks.

Yet another preferred embodiment inherent to supra, said processor units to instruct and specify said servers to network or connect said devices submitting images and associated information to said servers with relevant and network-selected devices based on said processed images and/or information. In other words, any touched or clicked image(s) and/or associated information in any touchscreens and/or opening screens submitted by any networked devices will cause said servers to network or link said devices submitting said images and/or information with networked deices in any loops to achieve live interactions of and among said looped devices being used by and among users of said networked devices.

Although various preferred embodiments of the present invention have been described, it will be appreciated by those skilled in the art that other preferred embodiments, adaptations, variations and derivatives are and will be made and achieved without departing from the spirit and the scope of the claims of the present invention.

1. A system for advising and guiding businesses, companies and corporations and people how to offer, examine, sell and buy goods and services through networks of fix and mobile communication devices networked to servers based on a plurality of adaptable series of complementary interactive images and pictures and associated information of said goods and services and related businesses, companies and corporations and consumers and buyers associating and endowed with a plurality of adaptable themes and trends and compositions of suggestions and recommendations of said goods and services offered, examined, bought and sold online by and among said businesses, companies, corporations and people in the viewing screens of relevant networked devices, said networked devices for submitting touched or clicked images and information in said viewing screens to networked servers, said system having said interactive images and information for instructing servers how to select images including submitted images and associated information from databases and to insert selected images associating with information into and replace, reorder and adapt said plurality of adaptable series and associating themes and trends and compositions of suggestions and recommendations in and among viewing screens of specific and networked devices, and said system having said interactive images and information for instructing said networked servers how to select images including submitted images and associated information from databases to compose said plurality of themes and trends and compositions of suggestions and recommendations associating and endowed with and inherent to a plurality of adaptable series of complementary images and associated generated by said processor units of said servers which disseminate said plurality of series associating with said plurality of themes and trends and compositions of suggestions and recommendations to specific and network-selected devices whenever said images and information are selected and submitted by said devices to said servers and said interactive images and associated information for networking with relevant and network-selected devices through networks, said plurality of adaptable series are rendered interactive in said viewing screens, said system comprises:
said networks comprising said servers including cloud and virtual servers comprising storage memories comprising databases generated in, by, disseminated and shared in said networks and devices comprising desktops, computer tablets, mobile communication devices including smartphones, satellites and teleconferencing platforms, said servers and devices comprising processor units coupled to innovative computer programs and software for instructing and specifying said processor units and said networked servers and devices, said servers and devices further have networking capabilities and technologies for streaming, pushing, pulling and sharing said plurality of adaptable series of images and associated information to, from and among said devices and servers in said networks, said viewing screens comprising touchscreens or touch-sensitive screens and opening screens of said devices;
said databases comprising relations of said images and associated information associating and endowed with said themes and trends and compositions of suggestions and recommendations expressed in said viewing screens of and among specific and network-selected devices;
said innovative computer programs and software for instructing said processor units how to compose a plurality of series of complementary images and associated information associating and endowed with adaptable themes and trends and compositions of suggestions and recommendations of goods and services offered, examined, sold and bought online by and among businesses, companies, corporations and people through networks from data on submitted images and associated information in said databases based on algorithms for instructing processor units of said servers how to generate, compose, change, adapt and update said plurality of adaptable series of images and associated information associating and endowed with said adaptable themes and trends and compositions of suggestions and recommendations including impressive, memorable and noteworthy themes and trends and compositions of suggestions and recommendations which are disseminated and streamed to said viewing screens of and among specific and network-selected devices consequent to images and associated information being selected and submitted by networked devices to said servers;
said innovative computer programs and software for instructing said servers to network or connect devices for submitting said images and associated information to and with relevant and network-selected devices in said networks;
algorithms for instructing said processor units of said servers how to:
i. compose said plurality of adaptable series associating and endowed with specific themes and trends and compositions of suggestions and recommendations in said viewing screens of and among specific and network-selected devices whenever said devices submitted images and associated information to said servers;
ii. generate and compose or change, adapt and update said plurality of said adaptable series of images and associated information associating and endowed with said plurality of adaptable themes and trends and compositions of suggestions and recommendations in said viewing screens of and among specific and network-selected devices based on submitted images and information relating to said databases in said storage memories, said adaptable series and associating adaptable themes and trends and compositions of suggestions and recommendations are relevant to specific and network-selected devices;
iii. compose impressive, memorable and noteworthy themes and trends and compositions of suggestions and recommendations associating with and inherent in said adaptable series of images and associated information;
iv. compose impressive, memorable and noteworthy themes, trends, suggestions and recommendations associating with and inherent in said adaptable series of images and associated information;
data analytics and statistics analyses for enabling said processor units to analyze and process submitted images and information with said databases to generate and compose or change, adapt and update said plurality of adaptable series associating and endowed with said plurality of adaptable themes and trends and compositions of suggestions and recommendations in said viewing screens of and among relevant, specific and network-selected devices based on said submitted images and information and compiled data on said goods and services offered, examined, sold and bought generated and submitted by and among said networked devices for generating and submitting images and information to said servers;
said interactive images and information for instructing said processor units of said servers to generate and compose a plurality of series of complementary images and associated information and associated adaptable themes and trends and compositions of suggestions and recommendations and said processor units for instructing said servers to disseminate said plurality of series and associated information and associated adaptable themes and trends and compositions of suggestions and recommendations to said viewing screens of and among specific and processor units-selected devices through networks;
said interactive images and information for instructing said processor units of said servers to change, adapt, update and reorder images and information in said adaptable series of complementary interactive images and associated information and associated adaptable themes and trends and compositions of suggestions and recommendations in said viewing screens of and among specific and network-selected devices through networks; and
said interactive images and information for instructing said processor units to instruct and specify said servers and devices to network said devices for submitting said images and associated information to and with relevant and network-selected devices through networks.

2. The system according to claim 1 wherein said plurality of adaptable series of interactive images and associated information and associating plurality of adaptable themes and trends and compositions of suggestions and recommendations in said viewing screens of and among networked devices are the products of server processor units processing images and associated information generated in processor units of networked devices and submitted by and among networked devices to said servers based on said algorithms and statistical analyses, said servers disseminating said plurality of adaptable series associating and endowed with adaptable themes and trends and compositions of suggestions and recommendations to said viewing screens of and among specific and network-selected devices.

3. The system according to claim 1 wherein said plurality of adaptable series of interactive images and associated information comprise a plurality of slide-shows of complementary interactive images or pictures and a plurality of complementary interactive displayed icons and tiles comprising displayed series, sequences and orders of images, pictures, icons and tiles to present relevant adaptable themes and trends and compositions of suggestions and recommendations in viewing screens to the eyes to impress and be perceived by the brains of viewers of said viewing screens, said interactive images, pictures, icons and tiles in said touchscreens and opening screens are linked to associating for presenting relevant adaptable themes and trends and compositions of suggestions and recommendations in viewing screens to the eyes to impress and be perceived by the brains of viewers, said information are retrieved and displayed in Web pages in said viewing screens.

4. The system according to claim 1 wherein said plurality of adaptable series of interactive images and associated information include a plurality of videos associating and endowed with adaptable themes and trends and compositions of suggestions and recommendations of goods and services offered, examined, sold and bought online by and among businesses, companies, corporations and people through networks.

5. The system according to claim 1 wherein said plurality of adaptable series of interactive images and associated information are interactive images, pictures, icons and tiles and information for instructing said processor units to instruct and specify said servers and devices to network said devices submitting said images and associated information to said servers with relevant and network-selected devices in said networks whenever said are interactive images, pictures, icons, tiles and information are touched and clicked in said viewing screens.

6. The system according to claim 1 wherein said databases comprising relations of said images and associated information associating and endowed with said themes and trends and compositions of suggestions and recommendations being expressed in said viewing screens comprise data on the numbers, sequences, frequencies, repetitions and recurrences referencing to time and spatial locations of touched or clicked images and associated or without information submitted touched or clicked images with associating information or without information, durations between each touched or clicked image and associated information and the next touched or clicked image and associated information, sharing and insertions of said touched or clicked images and associated information in and among networked devices, identities of said devices and demographics of users of said devices, said compositions of sequences of touched or clicked images and associated information in an adaptable series of interactive images and associated information in a touchscreen or an opening screen, said data are processed by said processor units and stored in said databases.

7. The system according to claim 1 wherein said databases comprising relations of said images and associated information associating and endowed with said themes and trends and compositions of suggestions and recommendations expressed in said viewing screens comprise data on the numbers, sequences, frequencies, repetitions and recurrences referencing to time and spatial locations of touched or clicked images and associated or without information submitted touched or clicked images with associating information or without information, durations between each touched or clicked image and associated information and the next touched or clicked image and associated information, sharing and insertions of said touched or clicked images and associated information in and among networked devices, identities of said devices and demographics of users of said devices, said compositions of sequences of touched or clicked images and associated information in a plurality of adaptable series of interactive images and associated information in a touchscreen or an opening screen, said data are processed by said processor units and stored in said databases.

8. The system according to claim 1 wherein said interactive images and information in networked devices for instructing said processor units to generate and compose a plurality of series of complementary images and associated information and associated adaptable themes and trends and compositions of suggestions and recommendations and said processor units for instructing said servers to disseminate said plurality of series and associated information and associated adaptable themes and trends and compositions of suggestions and recommendations to said viewing screens of and among specific and processor units-selected devices through networks comprise interactive images and associated information in first networked devices wherein said images and associated information are related to a plurality of images and associated information in said databases and being displayed as a plurality of interactive images including said images and associated information in the viewing screens in and among specific and relevant networked second devices, said images and information in said first networked devices wherein said images and information for getting said a plurality of images and associated information associating with plurality of adaptable themes and trends and compositions of suggestions and recommendations to be displayed in said viewing screens of and among specific and processor units-selected devices including said first devices from said databases through networks.

9. The system according to claim 1 wherein said interactive images and information in networked devices for instructing said processor units of said servers to change, adapt, update and reorder images and information in adaptable series of complementary interactive images and associated information and associated adaptable themes and trends and compositions of suggestions and recommendations in said viewing screens of and among specific and network-selected devices comprise said interactive images and associated information in first networked devices wherein said images and associated information are related to a plurality of images and associated information in said databases and being displayed as a plurality of interactive images including said images and associated information in the viewing screens in and among specific and relevant networked second devices, said images and information in first networked devices wherein said images and information for updating, changing and adapting a plurality of adaptable series of interactive images and associated information and associated adaptable themes and trends and compositions of suggestions and recommendations in the viewing screens of specific and network-selected second devices through networks.

10. In a system for advising and guiding businesses, companies and corporations and people how to offer, examine, sell and buy goods and services through networks of fix and mobile communication devices networked to servers based on a plurality of adaptable series of complementary interactive images and pictures and associated information of said goods and services and related businesses, companies and corporations and consumers and buyers associating and endowed with a plurality of adaptable themes and trends and compositions of suggestions and recommendations of said goods and services offered, examined, sold and bought by and among said businesses, companies, corporations and people in the viewing screens of relevant networked devices, a method for sharing and disseminating experiences and knowledge on offerings, examinations, sells and buys of goods and services by and among businesses, companies and corporations and consumers and buyers through networks, said method using a plurality of adaptable themes and trends and compositions of suggestions and recommendations associating and endowed with and inherent in said plurality of adaptable sequences of complementary interactive images and associated information composed and adapted by processor units of said servers which disseminate said pluralities to the viewing screens of and among specific and network-selected devices in said networks, said pluralities are constantly changed, adapted and updated in and among network-selected devices by said servers whenever the processor units of said servers processed submitted pictures and information submitted by said networked devices with the databases in said servers, said method comprises processes for:
operating said networks comprising said servers including cloud and virtual servers comprising storage memories comprising said databases generated in, by, disseminated and shared in said networks and devices comprising desktops, computer tablets, mobile communication devices including smartphones, satellites and teleconferencing platforms having viewing screens, said servers and devices comprising said processor units coupled to innovative computer programs and software and algorithms for instructing and specifying said processor units of said networked servers and devices, said servers and devices have networking capabilities and technologies for streaming, pushing, pulling and sharing said plurality of adaptable series of images and associated information associating and endowed with said adaptable themes and trends and compositions of suggestions and recommendations to, from and among said devices and servers in said networks, said viewing screens comprising touchscreens or touch-sensitive screens and opening screens;
said innovative computer programs and software to instruct said processor units of said servers how to:
i. compose a plurality of series of complementary images and associated information associating and endowed with adaptable themes and trends and compositions of suggestions and recommendations of goods and services offered, examined, sold and bought by and among businesses, companies, corporations and people through networks from data on submitted images and associated information in said databases based on algorithms for instructing processor units of said servers how to generate, compose, change, adapt and update said plurality of adaptable series of images and associated information associating and endowed with said adaptable themes and trends and compositions of suggestions and recommendations which are disseminated to said viewing screens of and among specific and network-selected devices consequent to images and associated information being selected and submitted by networked devices to said servers;
ii. process and compile images and associated information of said offered, examined, sold and bought goods and services and related businesses, companies and corporations and consumers and buyers shared and submitted by and among said networked devices, the outcomes of said processed data including relevant themes and trends and compositions of suggestions and recommendations are stored in said databases;
iii. compose a plurality of series of complementary images and associated information associating and endowed with adaptable themes and trends and compositions of suggestions and recommendations of goods and services offered, examined, sold and bought by and among businesses, companies, corporations and people through networks from data on submitted images and associated information in said databases based on said algorithms instructing said processor units of said servers how to generate, compose, change, adapt and update said plurality of adaptable series of images and associated information associating and endowed with said adaptable themes and trends and compositions of suggestions and recommendations, said servers to disseminate said plurality of adaptable series and associating themes and trends and compositions of suggestions and recommendations to said viewing screens of and among specific and network-selected devices whenever images and associated information are selected and submitted by networked devices to said servers;
iv. use said data analytics and statistics analytics to analyze and process submitted images and information with said databases to generate, compose, change, adapt and update said plurality of adaptable series associating and endowed with said plurality of adaptable themes and trends and compositions of suggestions and recommendations including impressive, memorable and noteworthy themes and trends and compositions of suggestions and recommendations in said viewing screens of and among relevant, specific and network-selected devices based on compiled data on said goods and services offered, examined, sold and bought generated and submitted by and among said networked devices for generating and submitting images and information to said servers;
v. compose, change, update and adapt individual adaptable series of complementary images and associated information and individual images and associated information in individual adaptable series based on individual themes and trends and compositions of suggestions and recommendations of goods and services to be generated and displayed in and among specific and processor units-selected devices whenever images and associated information are generated and submitted to said servers by and among said networked devices, said processor units are instructed by said algorithms and data analytics and statistical analyses of submitted images and information relating to data in said databases and plurality of series of complementary interactive images and pictures and associated information;
vi. instruct said servers to network or connect devices for submitting said images and associated information to and with relevant and network-selected devices in said networks;
said networks to use a plurality of specific adaptable themes and trends and compositions of suggestions and recommendations associating with and inherent in plurality of adaptable sequences of complementary interactive images and associated information in said viewing screens to disseminate and share said experiences and knowledge to and among said networked devices;
said processor units of said servers based on said algorithms provided by said innovative computer programs and software to:
i. compose said plurality of adaptable series associating and endowed with specific themes and trends and compositions of suggestions and recommendations in said viewing screens of and among specific and network-selected devices whenever said devices submitted images and associated information to said servers;
ii. generate and compose or change, adapt and update said plurality of said adaptable series of images and associated information associating and endowed with said plurality of adaptable themes and trends and compositions of suggestions and recommendations in said viewing screens of and among specific and network-selected devices based on submitted images and information relating to said databases in said storage memories, said adaptable series and associating adaptable themes and trends and compositions of suggestions and recommendations are relevant to specific and network-selected devices;
iii. compose impressive, memorable and noteworthy themes, trends, suggestions and recommendations associating and inherent in said adaptable series of images and associated information in and among networked devices;
said processor units of said servers to use data analytics and statistics analyses to analyze and process submitted images and information with said databases to generate and compose or change, adapt and update said plurality of adaptable series associating and endowed with said plurality of adaptable themes and trends and compositions of suggestions and recommendations in said databases and in said viewing screens of and among relevant, specific and network-selected devices based on said submitted images and information and compiled data on said goods and services offered, examined, sold and bought generated and submitted by and among said networked devices; and
said processor units to instruct and specify said servers and devices to network devices submitting images and associated information with relevant and network-selected devices through networks.

11. The method according to claim 10 wherein said process for said viewing screens of devices to instruct said processor units to adapt or compose a plurality of series of complementary images and associated information and associated adaptable themes and trends and compositions of suggestions and recommendations and said processor units to instruct and specify said servers how to disseminate said plurality of series and associated information and associated adaptable themes and trends and compositions of suggestions and recommendations to processor units-selected targeted viewing screens of and among specific and processor units-selected devices comprises a process for said computer programs and software to instruct and specify said processor units to process received images and information with said databases to compose or change, adapt, update and reorder series of images and information in a plurality of series or sequences of complementary and associated information associating and endowed with specific themes and trends and compositions of suggestions and recommendations based on said algorithms and data analytics and statistics analyses and said servers to disseminate, stream and push said adaptable outcomes to specific and processor units-selected touchscreens, opening screens and Web pages of and among specific and processor units-selected devices wherein said series and themes and trends and compositions of suggestions and recommendations are rendered as plurality series or sequences of complementary interactive images and associated information associating and endowed with plurality of adaptable themes and trends and compositions of suggestions and recommendations.

12. The method according to claim 10 wherein said plurality of adaptable series of interactive images and associated information comprise a plurality of slide-shows of complementary interactive images or pictures and a plurality of displays of complementary interactive icons and tiles comprising displayed series, sequences and orders of images, pictures, icons and tiles to present relevant adaptable themes and trends and compositions of suggestions and recommendations in viewing screens to the eyes to impress and be perceived by the brains of viewers of said viewing screens, said interactive images, pictures, icons and tiles in said touchscreens and opening screens are linked to associating information retrieved and displayed in Web pages in said viewing screens to present relevant adaptable themes and trends and compositions of suggestions and recommendations in viewing screens to the eyes to impress and be perceived by the brains of viewers.

13. The method according to claim 10 wherein said plurality of adaptable series of images and associated information include a plurality of videos associating and endowed with adaptable themes and trends and compositions of suggestions and recommendations of goods and services offered, examined, sold and bought by and among businesses, companies, corporations and people through networks.

14. The method according to claim 10 wherein said plurality of adaptable series of interactive images and associated information in said viewing screens are interactive images, pictures, icons and tiles and information which instruct said processor units to instruct and specify said servers and devices to network said devices submitting said images and associated information to said servers with relevant and network-selected devices in said networks whenever said interactive images, pictures, icons, tiles and information are touched and clicked in said viewing screens.

15. The method according to claim 10 wherein said process for algorithms provided by said innovative computer programs and software for instructing said processor units of said servers to compose impressive, memorable and noteworthy themes, trends, suggestions and recommendations associating and inherent in said adaptable series of images and associated information in and among networked devices comprises a process for computer programs and software to instruct and specify said processor units to process received images and information with said databases to compose series or sequences of images and information associating with compositions of impressive, memorable and noteworthy themes, trends and compositions of suggestions and recommendations to be same or similar to common cultural, social and entertainment messages and imprints according to diverse and different cultures and ethnicity in the human mind based on said algorithms and data analytics and statistics analyses of said databases.

16. In a system of plurality of adaptable series of interactive images and associated information for advising and guiding businesses, companies and corporations and people how to offer, examine, sell and buy goods and services through networks of fix and mobile communication devices and servers, a method for said plurality of adaptable themes and trends and compositions of suggestions and recommendations associating with and inherent in said plurality of adaptable series of complementary interactive images and associated information for advising and guiding the offerings, examinations, sells and purchases of goods and services by and among businesses, companies, corporations and people through networks in the viewing screens including touchscreens and opening screens of said devices, said interactive images and associated information in and among networked devices change, adapt and update said plurality of adaptable series and associated adaptable themes and trends and compositions of suggestions and recommendations in the viewing screens in and among specific and network-selected devices based on algorithms instructing processor units how to relate selected and submitted images and information with databases in the storage memories of said servers and how said servers disseminate plurality of adaptable series of images and associated information associating and endowed with plurality of adaptable themes and trends and compositions of suggestions and recommendations to said viewing screens in and among specific and network-selected devices, said method comprises processes for:
operating said networks comprising said servers including cloud and virtual servers comprising storage memories comprising said databases generated in, by, disseminated and shared in said networks and devices comprising desktops, computer tablets, mobile communication devices including smartphones, satellites and teleconferencing platforms having viewing screens, said servers and devices comprising said processor units coupled to innovative computer programs and software and algorithms for instructing and specifying said processor units of said networked servers and devices, said servers and devices have networking capabilities and technologies for streaming, pushing, pulling and sharing said plurality of adaptable series of images and associated information associating and endowed with said adaptable themes and trends and compositions of suggestions and recommendations to, from and among said devices and servers in said networks, said viewing screens comprising touchscreens or touch-sensitive screens and opening screens;
said innovative computer programs and software to instruct said processor units of said servers how to:
i. compose a plurality of series of complementary images and associated information associating and endowed with adaptable themes and trends and compositions of suggestions and recommendations of goods and services offered, examined, sold and bought by and among businesses, companies, corporations and people through networks from data on submitted images and associated information in said databases based on algorithms for instructing processor units of said servers how to generate, compose, change, adapt and update said plurality of adaptable series of images and associated information associating and endowed with said adaptable themes and trends and compositions of suggestions and recommendations which are disseminated to said viewing screens of and among specific and network-selected devices consequent to images and associated information being selected and submitted by networked devices to said servers;
ii. process and compile images and associated information of said offered, examined, sold and bought goods and services and related businesses, companies and corporations and consumers and buyers shared and submitted by and among said networked devices, the outcomes of said processed data including relevant compositions of themes and trends and compositions of suggestions and recommendations are stored in said databases;
iii. compose a plurality of series of complementary images and associated information associating and endowed with adaptable themes and trends and compositions of suggestions and recommendations of goods and services offered, examined, sold and bought by and among businesses, companies, corporations and people through networks from data on submitted images and associated information in said databases based on said algorithms instructing said processor units of said servers how to generate, compose, change, adapt and update said plurality of adaptable series of images and associated information associating and endowed with said adaptable themes and trends and compositions of suggestions and recommendations, said servers to disseminate said plurality of adaptable series and associating themes and trends and compositions of suggestions and recommendations to said viewing screens of and among specific and network-selected devices whenever images and associated information are selected and submitted by networked devices to said servers;
iv. use said data analytics and statistics analytics to analyze and process submitted images and information with said databases to generate, compose, change, adapt and update said plurality of adaptable series associating and endowed with said plurality of adaptable themes and trends and compositions of suggestions and recommendations including impressive, memorable and noteworthy themes and trends and compositions of suggestions and recommendations in said viewing screens of and among relevant, specific and network-selected devices based on compiled data on said goods and services offered, examined, sold and bought generated and submitted by and among said networked devices for generating and submitting images and information to said servers;
v. compose, change, update and adapt individual adaptable series of complementary images and associated information and individual images and associated information in individual adaptable series based on individual themes and trends and compositions of suggestions and recommendations of goods and services to be generated and displayed in and among specific and processor units-selected devices whenever images and associated information are generated and submitted to said servers by and among said networked devices, said processor units are instructed by said algorithms and data analytics and statistical analyses of submitted images and information relating to data in said databases and plurality of series of complementary interactive images and pictures and associated information;
vi. instruct said servers to network or connect devices for submitting said images and associated information to and with relevant and network-selected devices in said networks;
said networks to use a plurality of specific adaptable themes and trends and compositions of suggestions and recommendations associating with and inherent in plurality of adaptable sequences of complementary interactive images and associated information in said viewing screens to disseminate and share said experiences and knowledge to and among said networked devices;
said processor units of said servers based on said algorithms provided by said innovative computer programs and software to:
i. compose said plurality of adaptable series associating and endowed with specific themes and trends and compositions of suggestions and recommendations in said viewing screens of and among specific and network-selected devices whenever said devices submitted images and associated information to said servers;
ii. generate and compose or change, adapt and update said plurality of said adaptable series of images and associated information associating and endowed with said plurality of adaptable themes and trends and compositions of suggestions and recommendations in said viewing screens of and among specific and network-selected devices based on submitted images and information relating to said databases in said storage memories, said adaptable series and associating adaptable themes and trends and compositions of suggestions and recommendations are relevant to specific and network-selected devices;
iii. compose impressive, memorable and noteworthy themes, trends, suggestions and recommendations associating and inherent in said adaptable series of images and associated information in and among networked devices;
said processor units of said servers to use data analytics and statistics analyses to analyze and process submitted images and information with said databases to generate and compose or change, adapt and update said plurality of adaptable series associating and endowed with said plurality of adaptable themes and trends and compositions of suggestions and recommendations in said databases and in said viewing screens of and among relevant, specific and network-selected devices based on said submitted images and information and compiled data on said goods and services offered, examined, sold and bought generated and submitted by and among said networked devices; and
said processor units to instruct and specify said servers and devices to network devices submitting images and associated information with relevant and network-selected devices through networks.

17. The method according to claim 16 wherein said process for said viewing screens of devices to instruct said processor units to adapt or compose a plurality of series of complementary images and associated information and associated adaptable themes and trends and compositions of suggestions and recommendations and said processor units to instruct and specify said servers how to disseminate said plurality of series and associated information and associated adaptable themes and trends and compositions of suggestions and recommendations to processor units-selected targeted viewing screens of and among specific and processor units-selected devices comprises a process for said computer programs and software to instruct and specify said processor units to process received images and information with said databases to compose or change, adapt, update and reorder series of images and information in a plurality of series or sequences of complementary and associated information associating and endowed with specific themes and trends and compositions of suggestions and recommendations based on said algorithms and data analytics and statistics analyses and said servers to disseminate, stream and push said adaptable outcomes to specific and processor units-selected touchscreens, opening screens and Web pages of and among specific and processor units-selected devices wherein said series and themes and trends and compositions of suggestions and recommendations are rendered as plurality series or sequences of complementary interactive images and associated information associating and endowed with plurality of adaptable themes and trends and compositions of suggestions and recommendations.

18. The method according to claim 16 wherein said plurality of adaptable series of interactive images and associated information comprise a plurality of slide-shows of complementary interactive images or pictures and a plurality of displays of complementary interactive icons and tiles comprising displayed series, sequences and orders of images, pictures, icons and tiles to present relevant adaptable themes and trends and compositions of suggestions and recommendations in viewing screens to the eyes to impress and be perceived by the brains of viewers of said viewing screens, said interactive images, pictures, icons and tiles in said touchscreens and opening screens are linked to associating information retrieved and displayed in Web pages in said viewing screens to present relevant adaptable themes and trends and compositions of suggestions and recommendations in viewing screens to the eyes to impress and be perceived by the brains of viewers.

19. The method according to claim 16 wherein said plurality of adaptable series of images and associated information include a plurality of videos associating and endowed with adaptable themes and trends and compositions of suggestions and recommendations of goods and services offered, examined, sold and bought by and among businesses, companies, corporations and people through networks.

20. The method according to claim 16 wherein said plurality of adaptable series of interactive images and associated information in said viewing screens are interactive images, pictures, icons and tiles and information which instruct said processor units to instruct and specify said servers and devices to network said devices submitting said images and associated information to said servers with relevant and network-selected devices in said networks whenever said interactive images, pictures, icons, tiles and information are touched and clicked in said viewing screens.
